(19) United States
(12) Patent Application Publication
(10) Pub. No.: US 2025/0150866 A1
(43) Pub. Date: May 8, 2025

(54) Determining Packet Loss in a Fronthaul Link

(71) Applicant: Telefonaktiebolaget LM Ericsson (publ), Stockholm (SE)

(72) Inventors: Eduardo Lins de Medeiros, Sundbyberg (SE); Igor Almeida, Indaiatuba-SP (BR); Andre Mendes Cavalcante, Indaiatuba, SP (BR); Stefan Höst, Svedala (SE)

(21) Appl. No.: 18/838,496

(22) PCT Filed: Feb. 18, 2022
(86) PCT No.: PCT/SE2022/050181

§ 371 Date: Aug. 14, 2024

(51) Int. Cl. H04W 24/08; H04L 43/0829

(52) U.S. Cl. CPC H04W 24/08; H04L 43/0829

(57) ABSTRACT

It is provided a method for determining packet loss in a fronthaul link between a baseband node and a radio node of a radio access network. The method being performed in a packet loss determiner. The method comprises: detecting at least one empty input data slot of a plurality of input data slots of a communication chain operation in a first time period, wherein the communication chain operation is one in a sequence of communication chain operations in a device on a receiving end of the fronthaul link; determining that data was intended to be provided to the at least one empty input data slot; and determining that a packet loss has occurred in the fronthaul link, based on the detecting the at least one empty input data slot and the determining that data was intended to be provided.

### TECHNICAL FIELD

The present disclosure relates to the field of fronthaul links in a radio communication network and in particular to determining packet loss in a fronthaul link.

### BACKGROUND

In order to meet the increasing demand for data in recent mobile broadband networks (such as 5G systems), innovative and practical deployment solutions are required. For instance, 5G systems support network interfaces in a Centralized/Cloud Radio Access Network (C-RAN) architecture. Such interfaces support splitting of radio access functionality between a remote radio node and a baseband node.

The connection between the baseband node and the remote node is referred to as a fronthaul link or fronthaul network. A commonly used interface over the fronthaul link is evolved Common Public Radio Interface (eCPRI). The fronthaul link can be used to carry baseband radio samples in packets, allowing the use of high volume, relatively low-cost Ethernet transceivers. Compression methods may be used in order to lower fronthaul bandwidth requirements.

The fronthaul links can be based on Internet Protocol (IP) or are bridged networks and can experience packet loss, e.g. due to congestion. An implicit effect of packet loss is that fronthaul issues may lead to longer term radio capacity impact, when radio interface control mechanisms, such as link adaptation, act on the data loss as if the data loss was due to radio interface issues, even though the data loss was independent of radio conditions.

WO2019112497A1 discloses a method for determining packet loss in a fronthaul link of a radio access network. The method is performed in a packet loss determiner and comprising the steps of: obtaining a set of UEs that are all scheduled to communicate over a radio interface in a scheduling interval; creating a subset of UEs, comprising a number of UEs, from the set of UEs, that are the UEs in the set being most vulnerable to fronthaul packet loss; determining, for each UE in the subset of UEs, whether the communication in the scheduling interval was unsuccessful; and determining a packet loss in the fronthaul link depending on to what extent each one of the UEs in the subset of UEs is determined to have had unsuccessful use of the radio interface.

### SUMMARY

One object is to improve how packet loss in a fronthaul link is detected.

According to a first aspect, it is provided a method for determining packet loss in a fronthaul link between a baseband node and a radio node of a radio access network. The method being performed in a packet loss determiner. The method comprises: detecting at least one empty input data slot of a plurality of input data slots of a communication chain operation in a first time period, wherein the communication chain operation is one in a sequence of communication chain operations in a device on a receiving end of the fronthaul link; determining that data was intended to be provided to the at least one empty input data slot; and determining that a packet loss has occurred in the fronthaul link, based on the detecting the at least one empty input data slot and the determining that data was intended to be provided.

The method may further comprise: determining an aggregate metric of fronthaul loss, based on at least one occurrence of the determining that a packet loss has occurred.

The method may further comprise: providing a metric signal, based on the aggregate metric, to a link adaptation module.

The metric signal may be used by the link adaptation module to determine when to disregard user equipment, UE, feedback in a subsequent link adaptation.

The method may further comprise: comparing the aggregate metric against a threshold; and providing a fronthaul loss signal to a link adaptation module when the aggregate metric indicates a fronthaul loss that is greater than the threshold.

The method may further comprise: determining, in the baseband node, the threshold based on a code rate of a data set encompassing data of the plurality of input data slots in the first time period.

The determining the threshold may be further based on a transmission attempt number, a redundancy version and/or an effective code rate for the data set.

The method may be applied for downlink communication, and wherein the communication chain operation is OFDM, orthogonal frequency domain multiplexing, and wherein each one of the plurality of input data slots is configured to contain at least one modulated symbol.

The method may be applied for downlink communication, and wherein the communication chain operation is precoding, and wherein each one of the plurality of input data slots is configured to contain at least one modulated symbol.

The method may be applied for downlink communication, and wherein the communication chain operation is modulation, and wherein each one of the plurality of input data slots is configured to contain at least one binary word.

The method may be applied for uplink communication, and wherein the communication chain operation is equalization, and wherein each one of the plurality of input data slots is configured to contain at least one complex value.

The method may be applied for uplink communication, and wherein the communication chain operation is layer de-mapping, and wherein each one of the plurality of input data slots is configured to contain at least one complex value.

The method may be applied for uplink communication, and wherein the communication chain operation is de-scrambling, and wherein each one of the plurality of input data slots is configured to contain at least one binary word from a demodulator.

The method may be applied for uplink communication, and wherein the communication chain operation is decoding, and wherein each one of the plurality of input data slots is configured to contain at least one descrambled binary word.

The method may be applied for uplink communication, and wherein the communication chain operation is demodulation or symbol de-mapping, and wherein each one of the plurality of input data slots is configured to contain a symbol as a complex number in frequency domain.

According to a second aspect, it is provided a packet loss determiner for determining packet loss in a fronthaul link between a baseband node and a radio node of a radio access network. The packet loss determiner comprises: a processor; and a memory storing instructions that, when executed by the processor, cause packet loss determiner to: detect at least one empty input data slot of a plurality of input data slots of a communication chain operation in a first time period, wherein the communication chain operation is one in a sequence of communication chain operations in a device on a receiving end of the fronthaul link; determine that data was intended to be provided to the at least one empty input data slot; and determine that a packet loss has occurred in the fronthaul link, based on the detecting the at least one empty input data slot and the determining that data was intended to be provided.

The packet loss determiner may further comprise instructions that, when executed by the processor, cause packet loss determiner to determine an aggregate metric of fronthaul loss, based on at least one occurrence of the determining that a packet loss has occurred.

The packet loss determiner may further comprise instructions that, when executed by the processor, cause packet loss determiner to provide a metric signal, based on the aggregate metric, to a link adaptation module.

The metric signal may be configured to be used by the link adaptation module to determine when to disregard user equipment, UE, feedback in a subsequent link adaptation.

The packet loss determiner may further comprise instructions that, when executed by the processor, cause packet loss determiner to: compare the aggregate metric against a threshold; and provide a fronthaul loss signal to a link adaptation module when the aggregate metric indicates a fronthaul loss that is greater than the threshold.

The packet loss determiner may further comprise instructions that, when executed by the processor, cause packet loss determiner to determine, in the baseband node, the threshold based on a code rate of a data set encompassing data of the plurality of input data slots in the first time period.

The instructions to determine the threshold may be further based on a transmission attempt number, a redundancy version and/or an effective code rate for the data set.

The packet loss determiner may be configured to be applied for downlink communication, wherein the communication chain operation is OFDM, orthogonal frequency domain multiplexing, and wherein each one of the plurality of input data slots is configured to contain at least one modulated symbol.

The packet loss determiner may be configured to be applied for downlink communication, wherein the communication chain operation is precoding, and wherein each one of the plurality of input data slots is configured to contain at least one modulated symbol.

The packet loss determiner may be configured to be applied for downlink communication, wherein the communication chain operation is modulation, and wherein each one of the plurality of input data slots is configured to contain at least one binary word.

The packet loss determiner may be configured to be applied for uplink communication, wherein the communication chain operation is equalization, and wherein each one of the plurality of input data slots is configured to contain at least one complex value.

The packet loss determiner may be configured to be applied for uplink communication, wherein the communication chain operation is layer de-mapping, and wherein each one of the plurality of input data slots is configured to contain at least one complex value.

The packet loss determiner may be configured to be applied for uplink communication, wherein the communication chain operation is de-scrambling, and wherein each one of the plurality of input data slots is configured to contain at least one binary word from a demodulator.

The packet loss determiner may be configured to be applied for uplink communication, wherein the communication chain operation is decoding, and wherein each one of the plurality of input data slots is configured to contain at least one descrambled binary word.

The packet loss determiner may be configured to be applied for uplink communication, wherein the communication chain operation is demodulation or symbol de-mapping, and wherein each one of the plurality of input data slots is configured to contain a symbol as a complex number in frequency domain.

According to a third aspect, it is provided a radio node comprising the packet loss determiner according to the second aspect.

According to a fourth aspect, it is provided a baseband node comprising the packet loss determiner according to the second aspect.

According to a fifth aspect, it is provided a computer program for determining packet loss in a fronthaul link between a baseband node and a radio node of a radio access network. The computer program comprises computer program code which, when executed on a packet loss determiner causes the packet loss determiner to: detect at least one empty input data slot of a plurality of input data slots of a communication chain operation in a first time period, wherein the communication chain operation is one in a sequence of communication chain operations in a device on a receiving end of the fronthaul link; determine that data was intended to be provided to the at least one empty input data slot; and determine that a packet loss has occurred in the fronthaul link, based on the detecting the at least one empty input data slot and the determining that data was intended to be provided.

According to a sixth aspect, it is provided a computer program product comprising a computer program according to the fifth aspect and a computer readable means comprising non-transitory memory in which the computer program is stored.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIG. 1 is a schematic diagram illustrating a cellular communication network where embodiments presented herein may be applied;

FIGS. 2A-C are schematic diagrams illustrating embodiments of where the packet loss determiner can be implemented;

FIG. 3 is a schematic diagram illustrating a matrix being an aggregate indication of data loss according to one embodiment;

FIG. 4 is a schematic diagram illustrating the matrix of FIG. 3 with loss indicators per data set;

FIG. 5 is a sequence diagram illustrating embodiments for fronthaul packet loss detection in the downlink;

FIG. 6 is a sequence diagram illustrating embodiments for fronthaul packet loss detection in the uplink;

FIGS. 7A-B are flow charts illustrating embodiments of methods for determining packet loss in a fronthaul link between a baseband node and a radio node of a radio access network;

FIG. 8 is a schematic diagram illustrating components of the packet loss determiner of FIGS. 2A-C;

FIG. 9 is a schematic diagram showing functional modules of the packet loss determiner of FIGS. 2A-C according to one embodiment; and

FIG. 10 shows one example of a computer program product comprising computer readable means.

### DETAILED DESCRIPTION

The aspects of the present disclosure will now be described more fully hereinafter with reference to the accompanying drawings, in which certain embodiments of the invention are shown. These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

According to embodiments presented herein, the robustness of link adaptation is improved for systems where a baseband node and a radio node are connected by packet-based fronthaul. The benefits of the invention are achieved by detecting which decoding failures were likely caused by fronthaul impairments. That information can be passed on to the link adaptation procedure, which can use it to avoid spectral efficiency degradation (e.g., avoid lowering MCS or decreasing transport block size due to fronthaul impairments) when the radio link was not the cause of the loss.

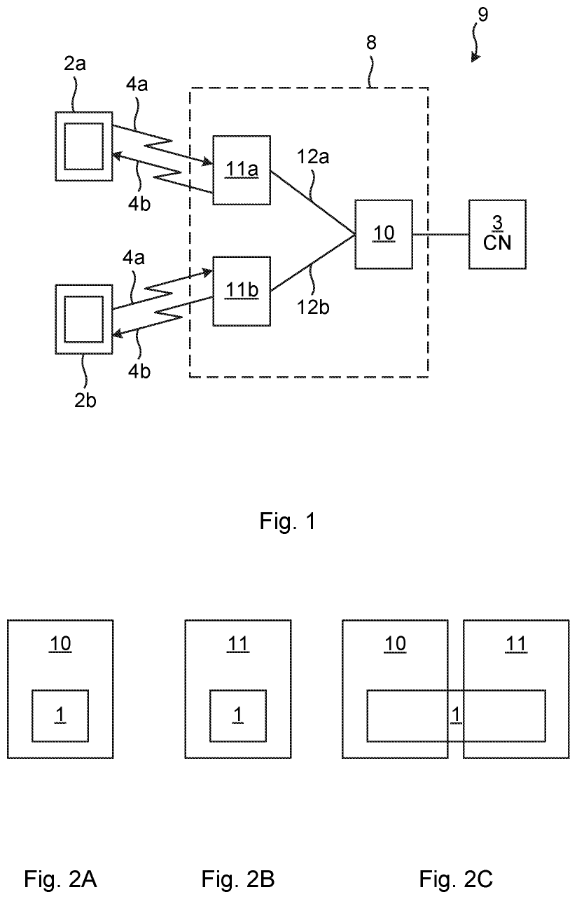

FIG. 1 is a schematic diagram illustrating a cellular communication network 9 where embodiments presented herein may be applied. The cellular communication network 9 comprises a core network 3 and one or more radio network nodes 8 part of a radio access network (RAN). The cellular communication network 9 can comply with any suitable current or future communication standard, e.g. LTE (Long Term Evolution), next generation mobile networks (fifth generation, 5G) employing NR (New Radio), UMTS (Universal Mobile Telecommunications System) utilising W-CDMA (Wideband Code Division Multiplex), CDMA2000 (Code Division Multiple Access 2000), or any other current or future wireless network, as long as the principles described hereinafter are applicable.

The radio network nodes can be the form of radio base stations being gNode Bs, gNBs, or evolved Node Bs, also known as eNode Bs or eNBs. The radio network nodes could also be in the form of Node Bs, BTSs (Base Transceiver Stations) and/or BSSs (Base Station Subsystems), etc. The radio network node 8 provides radio connectivity over a wireless interface 4a-b to a plurality of UEs (User Equipment) 2a-b. The radio network node can be implemented by at least one O-DU (O-RAN (Open RAN) distributed unit) and at least one O-RU (O-RAN radio unit).

Over the wireless interface, downlink (DL) communication 4b occurs from the radio network node 8 to the UEs 2a-b and uplink (UL) communication 4a occurs from the UEs 2a-b to the radio network node 8. The quality of the wireless radio interface to each UE 2a-b can vary over time and depending on the position of the UE 2a-b, due to effects such as fading, multipath propagation, interference, etc.

The radio network node 8 can comprise several antennas, e.g. in a MIMO antenna array to thereby enable beamforming to the UEs 2a-b by applying beamforming coefficients, respectively for each one of the antennas. The beamforming can be applied separately for each UE 2a-b or simultaneously for multiple UEs. The beamforming can be applied in downlink 4b and/or uplink 4a. A beam index defines the beamforming coefficients and may correspond to a direction from the radio to network node 8. Also, UL beamforming from the UE is possible.

The term UE is also known as mobile communication terminal, user device, mobile terminal, user terminal, user agent, wireless device, wireless terminal, machine-to-machine device etc., and can be, for example, what today are commonly known as a mobile phone, smart phone or a tablet/laptop with wireless connectivity.

The cellular communication network 9 may e.g. comply with any one or a combination of 5G NR (New Radio), LTE (Long Term Evolution), LTE-Advanced, WCDMA (Wideband Code Division Multiplex), or any other current or future wireless network, as long as the principles described herein are applicable.

The radio network node 8 is connected to the core network 3 for connectivity to network central functions and a wide area network, such as the Internet.

The radio network node 8 is here implemented in a distributed fashion, e.g. using a C-RAN (Centralised/Cloud Radio Access Network) architecture. The radio network node 8 comprises a baseband node 10 being a baseband processing unit and one or more (in this example two) remote radio nodes 11a-b. When applied in an O-RAN architecture, the baseband node can be an O-DU node and the radio node can be an O-RU node. The baseband node 10 and the remote radio nodes 11a-b can be in different locations. The baseband node 10 is located uplink from the remote radio nodes 11a-b, i.e. towards the core network 3. Consequently, the remote radio nodes 11a-b are located downlink from the baseband node 10, towards the UEs 2a-b. There are respective fronthaul links 12a-b between the baseband node 10 and the remote radio nodes 11a-b. The fronthaul links 12a-b are bidirectional communication links. The fronthaul links 12a-b can be implemented using a Common Public Radio Interface (CPRI) or eCPRI (evolved CPRI) and Ethernet. Multiple fronthaul links can be employed in other topologies than what is shown in FIG. 1. Multiple fronthaul links can also be denoted a fronthaul network. The baseband node 10 and the radio nodes 11a-b can each implement subsets of functionality for radio communication with the UEs 2a-b. Furthermore, some functionality for the radio communication can be virtualized, also known as cloud RAN (Radio Access Network).

FIGS. 2A-C are schematic diagrams illustrating embodiments of where the packet loss determiner can be implemented.

In FIG. 2A, the packet loss determiner 1 is shown implemented in the baseband node. The baseband node 10 is thus the host device for the packet loss determiner 1 in this implementation. This embodiment is particularly suitable for determining fronthaul packet loss in uplink communication.

In FIG. 2B, the packet loss determiner is shown implemented in the radio node 11. The radio node 11 is thus the host device for the packet loss determiner 1 in this implementation. This embodiment is particularly suitable for determining fronthaul packet loss in downlink communication.

In FIG. 2C, the packet loss determiner 1 is shown implemented partly in the baseband node 10 and partly in radio node 11. Both the baseband node 10 and the radio node 11 are thus host devices for the packet loss determiner 1 in this implementation. This embodiment can be applied for determining fronthaul packet loss in either or both uplink and downlink communication.

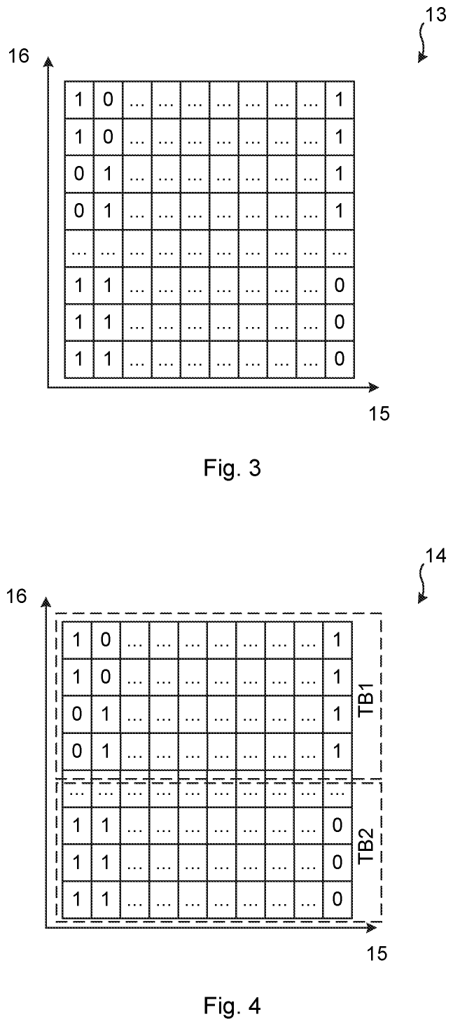

FIG. 3 is a schematic diagram illustrating a matrix illustrating an aggregate indication of data loss according to one embodiment. The horizontal axis 15 indicates an OFDM (orthogonal frequency domain multiplexing) symbol number (e.g. 14 OFDM symbols in one subframe) and the vertical axis 16 indicates a block (or equivalent group) of subcarriers (including a block/group of size 1) in an assigned frequency band.

The elements represent resources occupied by a codeword, and the ones and zeros in the matrix indicates presence or absence of data for an operation in a communication chain. A zero indicates a lack of data and a one indicates presence of data.

FIG. 4 is a schematic diagram illustrating the matrix of FIG. 3 with loss indicators per data set. In this example, the data set is a codeword, where each codeword comprises a number of resource elements. In this example, it is shown a first codeword TB1 and a second codeword TB2. The dashed lines indicate that scheduling information is available, which is used to determined when elements that have intended vs. unintended lack of data. In other words, data is expected for all elements inside a dashed block and any lack of data there would constitute unintended lack of data. The unintended lack of data can be aggregated to calculate a loss percentage, independently for each codeword. For instance, the first codeword TB1 can have a loss of 0.1% while the second codeword TB2 can have a loss of 0.5%.

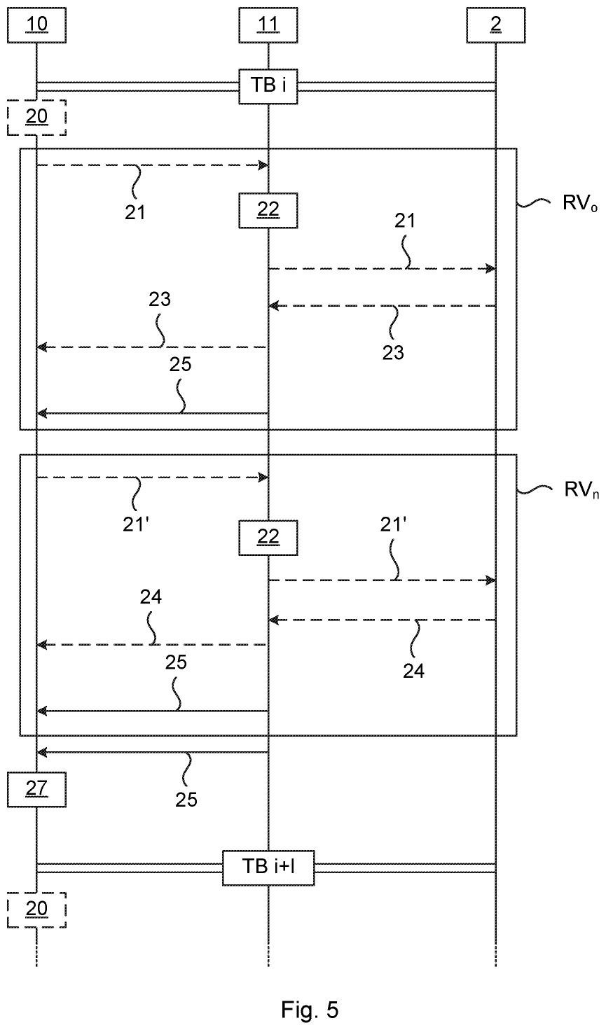

FIG. 5 is a sequence diagram illustrating embodiments for fronthaul packet loss detection in the downlink. This is provided to illustrate a downlink context in which embodiments presented herein can be applied. Messages or actions that are specific to embodiments presented herein are presented with solid lines, while messages or actions that are known are presented with dashed lines. The sequence diagram is based on link adaptation 20 being performed before each new transmission of a data set is started. In this example, the data set is in the form of a transport block. HARQ (Hybrid automatic repeat request) iterations are shown grouped by RV (redundancy version) number. It is to be noted that for NR, HARQ can be configured to operate on code-block groups, wherein a code block is a subset of a transport block.

For the first RV number, RV₀, the baseband node 10 sends a transport block TB 21 (TB i, RV₀) to the radio node 11. The radio node 11 collects and aggregates 22 data set loss metric (as described in more detail below) and transmits the transport block 21 to the UE 2. As part of the HARQ process, the UE here transmits a NACK 23 for TB i to the radio node 11. The NACK 23 indicates a failed reception. The radio node 11 forwards the NACK 23 to the baseband node 10. Optionally, as part of the RV₀ processing, the radio node 11 also sends an aggregated data set loss metric 25 to the baseband node 10.

Since a NACK was received, the baseband node 10 performs a retransmission. This occurs each time a NACK is received, whereby multiple retransmissions may occur. The retransmission is here denoted RVₙ. For this n:th RV number, RVₙ, the baseband node 10 sends a transport block TB 21′ (TB i, RVₙ) to the radio node 11. The radio node 11 again collects and aggregates 22 data set loss metric and transmits the transport block 21′ to the UE 2. As part of the HARQ process, the UE now transmits an ACK 24 for TB i to the radio node 11. The ACK 24 indicates a successful reception. The radio node 11 forwards the ACK 24 to the baseband node 10. Optionally, as part of the RVₙ processing, the radio node 11 also sends an aggregated data set loss metric 25 to the baseband node 10.

After the successful reception (indicated by the ACK 24), the radio node 11 sends an aggregated data set loss metric 25 to the baseband node 10. This allows the baseband node 10 to process TB loss feedback, to determine if the failed reception was due to issues in the fronthaul or in the radio interface. In the next TB, TB i+1, the link adaptation 20 is based on this information. For instance, if there were issues in the radio interface, the link adaptation 20 can choose a more robust MCS and/or TB size. On the other hand, if there were no issues in the radio interface, there would not be a reason for a conservative MCS and/or TB size, since this is not likely to improve issues in the fronthaul transmissions.

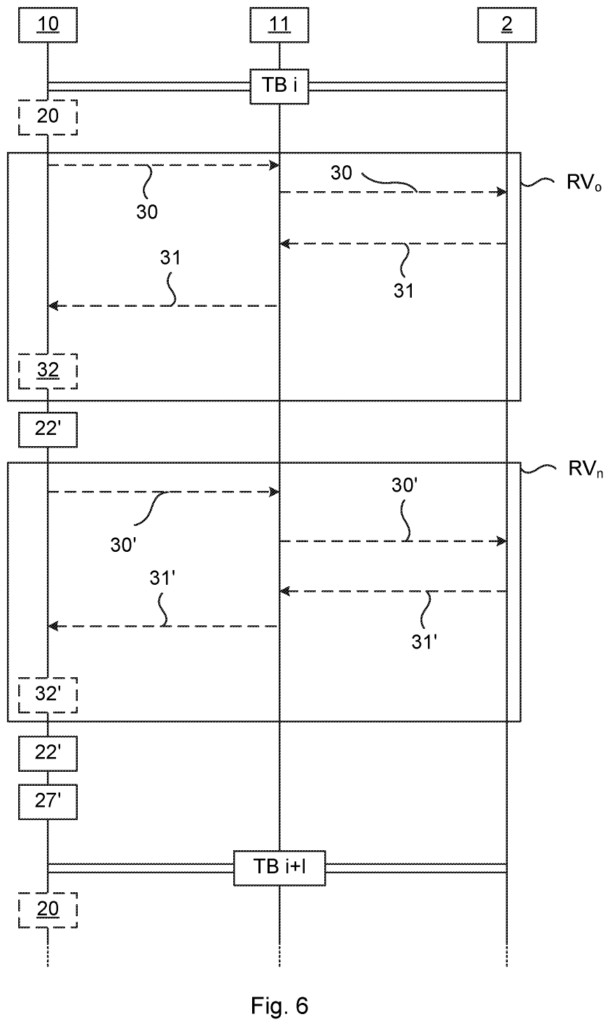

FIG. 6 is a sequence diagram illustrating embodiments for fronthaul packet loss detection in the uplink. This is provided to illustrate an uplink context in which embodiments presented herein can be applied. As for FIG. 5, messages or actions that are specific to embodiments presented herein are presented with solid lines, while messages or actions that are known are presented with dashed lines. The sequence diagram is based on link adaptation 20 being performed before each new data set. Also in this example, the data set is in the form of a transport block. HARQ iterations are shown grouped by RV number.

For the first RV number, RV₀, the baseband node 10 sends a TB request 30 (TB i, RV₀) to the radio node 11. The radio node 11 forwards the transport block request 30 to the UE 2. The TB request 30 is used for dynamic scheduling of UL traffic. However, it is to be noted that the TB request 30 is optional if scheduling of UL traffic is scheduled in a different way, e.g. using some form of pre-configuration of UL traffic. The UE 2 responds by transmitting a corresponding transport block 31 (TB i, RV 0) to the radio node 11. The radio node 11 forwards the TB 31 to the baseband node 10. The baseband node 10 decodes the TB 31 and determines a failed reception, i.e. NACK. The baseband node 10 collects and aggregates 22′ data set loss metric from the baseband node 10 perspective.

Since the decoding was unsuccessful, the baseband node 10 needs a retransmission from the UE, and sends a new TB request 30′ (TB i, RVₙ) to the radio node 11. The radio node 11 forwards the transport block request 30′ to the UE 2. The UE 2 responds by transmitting a corresponding transport block 31′ (TB i, RV n) to the radio node 11. The radio node 11 forwards the TB 31′ to the baseband node 10. The baseband node 10 decodes the TB 31′ and now determines a successful reception, i.e. ACK. The baseband node 10 collects and aggregates 22′ data set loss metric from the baseband node 10 perspective.

After the successful reception, the baseband node 10 processes the TB loss information, to determine if the one or more instances of failed reception was due to issues in the fronthaul or in the radio interface. In the next TB, TB i+1, the link adaptation 20 is based on this information. For instance, if there were issues in the radio interface, the link adaptation 20 can choose a more robust MCS and/or TB size. On the other hand, if there were no issues in the radio interface, there would not be a reason for a more conservative MCS and/or TB size, since this is not likely to improve issues in the fronthaul transmissions.

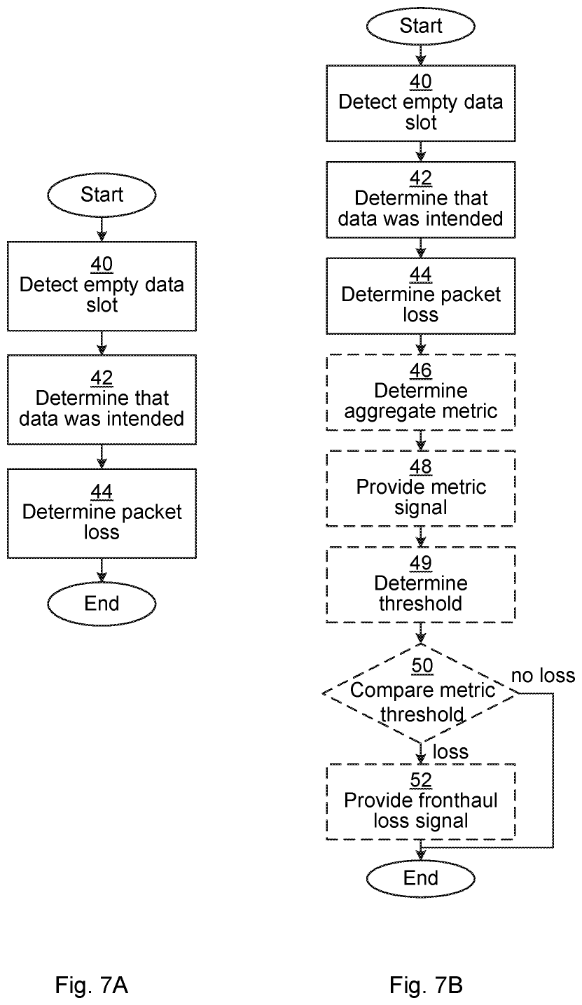

FIGS. 7A-B are flow charts illustrating embodiments of methods for determining packet loss in a fronthaul link between a baseband node and a radio node of a radio access network. The method is performed in a packet loss determiner 1. First, the embodiments illustrated by FIG. 7A will be described.

In a detect empty data slot step 40, the packet loss determiner 1 detects at least one empty input data slot of a plurality of input data slots of a communication chain operation in a first time period. Some examples of data slots (explained in more detail below) are a resource element in LTE/NR, a sequence of bits in a codeword, at least one time domain sample, at least one IQ (In-phase/Quadrature) sample (in frequency domain). The communication chain operation is one in a sequence of communication chain operations in a device on a receiving end of the fronthaul link 12a-b. The communication chain can be a downlink chain, in which case the packet loss determiner 1 can be implemented in the radio node 11. Alternatively, the communication chain can be an uplink chain, in which case the packet loss determiner 1 can be implemented in the baseband node 10. Hence, in the downlink, the device on the receiving end of the fronthaul link is the radio node, while in the uplink, the device on the receiving end of the fronthaul link is the baseband node.

The communication chain operation is an operation that is per se conventionally used for the communication chain and that has a deadline for receiving input data to the operation. Hence, for the downlink, examples of communication chain operations are modulation, precoding, OFDM, etc. For the uplink, examples of communication chain operations are equalization, layer de-mapping, de-scrambling, decoding, demodulation, etc.

In any case, this step detects when there is at least one empty input data slot for the communication chain operation in question. Later, this is checked against other sources (such as scheduling data) to determine whether the absent empty input data slot was intentional or unintentional, i.e. due to loss that can be assumed to be fronthaul link loss.

The empty data slot can thus be an indication of a fronthaul packet loss for operations that are executed with a deadline in any one of multiple possible locations in the (downlink or uplink) communication chain.

When the method is applied for downlink communication, the communication chain operation can be OFDM modulation. In this case, each one of the plurality of input data slots is a bin configured to contain at least one modulated symbol. Both LTE and NR use OFDM as a modulation scheme. In the downlink, the OFDM modulator operates at regular intervals. At each OFDM symbol deadline, modulated symbols to be transmitted need to be available at the input of an IFFT (Inverse Fast Fourier Transform) module of the OFDM modulator. The modulated symbols can e.g. be modulated according to any one of BPSK (Binary Phase-Shift Keying), QPSK (Quadrature Phase-Shift Keying) and QAM (Quadrature Amplitude Modulation). If that is not the case, any missing input is filled with a suitable default value (e.g. 0). The procedure for OFDM input evaluation can e.g. be triggered by a hardware interrupt. Empty bins need to be known to be filled with default values, or conversely, it is known which bins were filled if a subset of the inputs is filled with the default value. The radio node can thus keep track of what subcarriers were empty in any OFDM symbol and could derive (e.g. in step 46 mentioned below) a data set metric such as a bitmap representing what content was lost (e.g., due to packet losses or packets arriving too late for the OFDM symbol deadline).

When the method is applied for downlink communication, the communication chain operation can be precoding. Precoding can be implemented by applying a precoding matrix to adapt transmission to the radio communication channel. Precoding can also be implemented as a modification of the modulated symbols prior to OFDM transmission (e.g., after symbol mapping and before iFFT (inverse fast Fourier transform)), in which case the precoding is not implemented by a precoding matrix. Precoding can further be implemented as a filtering operation in the time-domain after OFDM modulation and before digital-to-analogue conversion. In this case, each one of the plurality of input data slots is configured to contain at least one modulated symbol. When the radio node is responsible for precoding operations, a vector of modulated symbols at the input to the precoder must be available at regular intervals. The radio node can keep track of which precoder inputs were missing and could derive (e.g. in step 46 mentioned below) from it a data set metric such as a bitmap representing what content was lost.

When the method is applied for downlink communication, the communication chain operation can be modulation, e.g. QAM modulation. In this case, each one of the plurality of input data slots is configured to contain at least one binary word. The modulation can be used for symbol mapping a vector of input binary words. The binary words need to be available at the symbol mapper inputs at regular intervals. The radio node can keep track of which symbol mapper inputs were missing, and could derive (e.g. in step 46 mentioned below) from it a feedback signal such as a bitmap representing what content was lost.

When the method is applied for uplink communication, the communication chain operation can be equalization. The equalization, as known in the art per se, is the process of finding an inverse operation that compensates for effects of a radio channel transfer function, including compensating for actions taken by the transmitter, such as precoding, or general form, to improve the quality of the received signal (e.g., by focusing on directions that contain more signal energy instead of interference). The equalization process may include operations that affect multiple layers simultaneously (e.g., matrix multiplication). In this case, each one of the plurality of input data slots is configured to contain at least one complex value, e.g. in the form of a frequency domain IQ (In-phase/quadrature) sample. The complex values to be equalized need to be available at the equalizer inputs at regular intervals. Therefore, the baseband node can keep track of which equalizer inputs were missing and could derive from it a data set loss metric such as a bitmap representing what content was lost. It is to be noted that when the term data set is used herein, it is be construed as any set of data for which fronthaul loss metrics are feasible and beneficial. For instance, the data set can be a transport block, a codeword, a code-block group, etc.

When the method is applied for uplink communication, the communication chain operation can be layer de-mapping. In this case, each one of the plurality of input data slots is configured to contain at least one complex value (e.g., at least one complex value per layer). The complex values to be de-mapped (e.g., reordered into one or more codewords to be decoded) need to be available at the de-mapper inputs at regular intervals. Therefore, the baseband node can keep track of which de-mapper inputs were missing and can derive from it a data set loss metric such as a bitmap representing what content was lost.

When the method is applied for uplink communication, the communication chain operation can be demodulation or symbol de-mapping. In this case, each one of the plurality of input data slots is configured to contain a symbol as a complex number in the frequency domain.

When the method is applied for uplink communication, the communication chain operation can be de-scrambling. In this case, each one of the plurality of input data slots is configured to contain at least one binary word from a demodulator.

When the method is applied for uplink communication, the communication chain operation can be decoding, e.g. using a LDPC (Low-Density Parity-Check) decoder or turbo decoder. In this case, each one of the plurality of input data slots is configured to contain at least one descrambled binary word. The binary word at the input to the decoder needs to be in the correct bit ordering prior to the decoding operation. The baseband can keep track of which bits were missing and can derive from it a data set loss metric such as a bitmap representing what content was lost.

In a determine that data was intended step 42, the packet loss determiner 1 determines that data was intended to be provided to the at least one empty input data slot. This can be achieved by comparing empty data slots against corresponding scheduling. In one uplink scenario, a UE may be located close to the cell border. The UE may transmit UL data, but when the data is received, the reception is below or close to the noise floor. In order to address this scenario, for uplink, the determination of intended data can take into account auxiliary information indicative of radio channel quality, such as reference signals power/magnitude, a channel estimate calculated by the radio or baseband, an estimate of path loss or similar. In this way, false positives due to cell edge users can in many cases be avoided.

The intent can be determined using scheduling information, such that all data inside a scheduling grant is intended to be filled. In this way, where there is a lack of data there, this is determined to be a loss in the fronthaul link. For UL, intent of data in can be determined using pilot signals, channel estimates, path loss in conjunction with scheduling.

In a determine packet loss step 44, the packet loss determiner 1 determines that a packet loss has occurred in the fronthaul link 12a-b, based on the detecting the at least one empty input data slot and the determining that data was intended to be provided.

Looking now to FIG. 7B, only new or modified steps compared to FIG. 7A will be described.

In an optional determine aggregate metric step 46, the packet loss determiner 1 determines an aggregate metric of fronthaul loss, based on at least one occurrence of the determining 44 that a packet loss has occurred.

For instance, the aggregate metric can be a loss percentage described above with reference to FIG. 4, indicating a percentage of fronthaul loss in a data set. Another example of an aggregate metric is a count of resource elements (the smallest block in the time-frequency grid, corresponding to one subcarrier in an OFDM symbol) that experience fronthaul loss, aggregated over a slot (NR), subframe (LTE) or other relevant time interval. Another example of an aggregate metric is a count of resource blocks (groups of 12 subcarriers in a symbol) that experience fronthaul loss, possibly grouped over a slot (14 symbols), subframe or other relevant time interval. Another example of an aggregate metric is a ratio of any of the preceding metrics and the size of the relevant data set for a given slot, subframe or other relevant time interval. Any of the mentioned aggregate metrics can be averaged over retransmissions for the same data set. For instance, if there were retransmissions (3 attempts), the quantity is then divided by 3. The metric can be further aggregated over time and fed back to the baseband node (in downlink) or calculated by the baseband module (in uplink).

In an optional provide metric signal step 48, the packet loss determiner 1 provides a metric signal, based on the aggregate metric, to a link adaptation module. The metric signal can be used by the link adaptation module to determine when to disregard UE feedback in a subsequent link adaptation. It is to be noted that it is not necessary to provide the metric signal before any UE HARQ feedback, as long as the link adaptation module has sufficient time to consider the metric signal prior to the next link adaptation. In the downlink, the metric signal may need to be communicated over the fronthaul link/network to the baseband node, e.g. as a packet of a real-time control data message in eCPRI. The packet can be a normal-priority packet or a high-priority packet. In the uplink, the metric signal might be able to be communicated within the same physical device or adjacent devices. The metric signal can comprise a slot identifier, frame number or subframe number for which the metric concerns, a HARQ process identifier, a UE identifier, a user identifier, and/or an identifier for a time interval or transmission attempt.

In an optional determine threshold step 49, the packet loss determiner 1 determines, in the baseband node 10, a threshold (for considering when aggregate metric is to be considered large enough to act upon) based on a code rate of a data set encompassing data of the plurality of input data slots in the first time period. Optionally, the determining the threshold is further based on a transmission attempt number, a redundancy version and/or an effective code rate for the data set. It is to be noted that thresholds may differ between the uplink and the downlink.

If the threshold is set too low, some transmissions will be early flagged as a decoding failure, while the UE may still succeed in decoding the data set. If the threshold is set too high, some decoding failures caused by fronthaul will not be detected (leading to spectral efficiency degradation).

The threshold value can be obtained by means of link-level simulation, where a TB is generated, punctured in a controlled manner to simulate loss, and fed to the decoder to evaluate decoding outcome. Statistics of the decoding outcomes can be used to select the threshold (e.g., if the code rate is 7/8, in the first transmission attempt, a loss of 2% in fronthaul cause a decoding failure in 99.9% of cases). The threshold can also be set to a value that is higher than the number of errors the code can correct (at the effective code rate for that transmission attempt).

For implementation purposes, the threshold values obtained via link-level simulation may be stored in a look-up table and used by the baseband node accordingly. For instance, the lookup table can be indexed by the code rate and RV number.

The higher MCS values are more sensitive to decoding issues, since a smaller fraction of lost content leads to decrease their success rate. Given an operating point (defined by a target BLER (Block error rate)) and the assumption that link adaptation is working reasonably well, the threshold can be defined as the data set metric that increases the BLER beyond the target (i.e., operating point).

The threshold value can be optimized by the baseband node in operation. One way to achieve this is to increase the threshold when a loss is deemed significant, but the UE still reports a successful decoding outcome (ACK).

In an optional conditional compare metric threshold step 50, the packet loss determiner 1 compares the aggregate metric against a threshold. When loss is determined, the method proceeds to a provide fronthaul loss signal step 52. Otherwise, the method ends.

In an optional provide fronthaul loss signal step 52, the packet loss determiner provides a fronthaul loss signal to a link adaptation module when the aggregate metric indicates a fronthaul loss that is greater than the threshold. This fronthaul loss signal can be an alternative or in addition to providing the metric signal to the link adaptation module, that is performed in step 48.

Each HARQ feedback can be associated with an indication of whether a decoding failure was caused by fronthaul impairments or not. Alternatively, the implementation can also provide the data set metric associated with each HARQ feedback to the link adaptation procedure.

When provided with information of the fronthaul loss, either by the metric signal of step 48 and/or by the fronthaul loss signal of step 52, the link adaptation module can compare this (if not performed previously) with corresponding ACK/NACK information, number of transmission attempts, previous MCS, CQI, measurements reported by the UE, etc. This allows the link adaptation to distinguish between NACKs due to fronthaul packet loss or due to air interface issues. Only when the NACKs are due to air interface issues is the radio link made more robust, e.g. by modifying the MCS or TB size for the UE. In this way, an efficient detection of fronthaul losses is provided that tailors link adaptation more on radio conditions, rather than data loss in general.

The air interface channel (between the radio node and the UE) and fronthaul network conditions are relatively independent. Consider an example where a cell, using some OFDM-based radio physical layer, is operating in normal conditions. Groups of UEs are scheduled and report their channel conditions, based on which link adaptation is performed. If, at this point, a burst of fronthaul packet errors occur, signal content will be lost, CRC (cyclic redundancy check) checks may be missed and subsequently retransmissions will be necessary for a subset of the UEs.

If the RAN scheduler is unaware of whether the event is due to fronthaul packet loss or air interface issues, it will assume that the air interface channel conditions have deteriorated and may react by choosing a more conservative MCS (modulation and coding scheme) values or reduce TB size. This will lower spectral efficiency unnecessarily if the reason for the lost signal was a fronthaul packet loss, since the air interface channel may still have good conditions. Hence, according to the embodiments presented herein, if a fronthaul packet loss is detected, the scheduler can avoid lowering the MCS/reducing TB size unnecessarily.

Embodiments presented herein abstract a fronthaul impairment issue into a network-agnostic, actionable notification that is naturally used by the RAN scheduler. This mitigates coupling between fronthaul interface implementation and baseband implementation. Embodiments presented herein do not depend on reports from transport equipment. Enabling the scheduler to detect problems in the fronthaul bypasses the need for cooperation between network nodes (i.e., in RAN and transport).

Moreover, embodiments presented herein do not depend on extra entities in the network (SDN (software-defined networking) controllers, network managers or fronthaul managers). The solution can be implemented in currently provided baseband nodes and radio nodes, using interfaces that already exist (e.g., using real time control packets in eCPRI). No changes to telecommunication standards are needed.

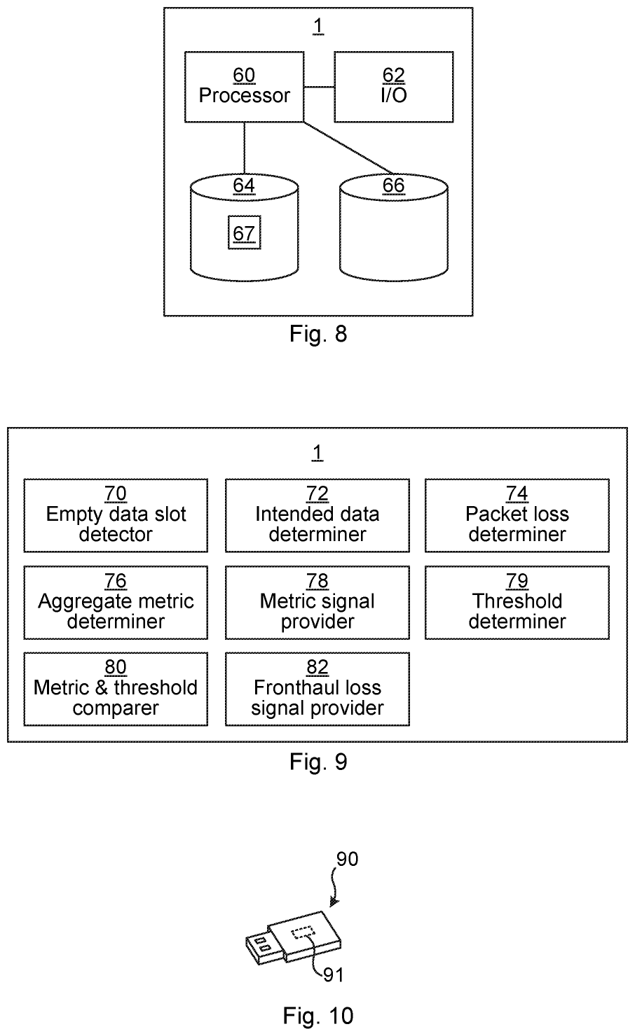

FIG. 8 is a schematic diagram illustrating components of the packet loss determiner 1 of FIGS. 2A-C. It is to be noted that when the packet loss determiner 1 is implemented in a host device, one or more of the mentioned components can be shared with the host device. A processor 60 is provided using any combination of one or more of a suitable central processing unit (CPU), graphics processing unit (GPU), multiprocessor, microcontroller, digital signal processor (DSP), etc., capable of executing software instructions 67 stored in a memory 64, which can thus be a computer program product. The processor 60 could alternatively be implemented using an application specific integrated circuit (ASIC), field programmable gate array (FPGA), etc. The processor 60 can be configured to execute the method described with reference to FIGS. 7A-B above.

The memory 64 can be any combination of random-access memory (RAM) and/or read-only memory (ROM). The memory 64 also comprises non-transitory persistent storage, which, for example, can be any single one or combination of magnetic memory, optical memory, solid-state memory or even remotely mounted memory.

A data memory 66 is also provided for reading and/or storing data during execution of software instructions in the processor 60. The data memory 66 can be any combination of RAM and/or ROM.

The packet loss determiner 1 further comprises an I/O interface 62 for communicating with external and/or internal entities.

Other components of the packet loss determiner 1 are omitted in order not to obscure the concepts presented herein.

FIG. 9 is a schematic diagram showing functional modules of the packet loss determiner 1 of FIGS. 2A-C according to one embodiment. The modules are implemented using software instructions such as a computer program executing in the packet loss determiner 1. Alternatively or additionally, the modules are implemented using hardware, such as any one or more of an ASIC (Application Specific Integrated Circuit), an FPGA (Field Programmable Gate Array), or discrete logical circuits. The modules correspond to the steps in the methods illustrated in FIGS. 7A-B. An empty data slot detector 70 corresponds to step 40. An intended data determiner 72 corresponds to step 42. A packet loss determiner 74 corresponds to step 44. An aggregate metric determiner 76 corresponds to step 46. A metric signal provider 78 corresponds to step 48. A threshold determiner 79 corresponds to step 49. A metric and threshold comparer 80 corresponds to step 50. A fronthaul loss signal provider 82 corresponds to step 52.

FIG. 10 shows one example of a computer program product 90 comprising computer readable means. On this computer readable means, a computer program 91 can be stored in a non-transitory memory. The computer program can cause a processor to execute a method according to embodiments described herein. In this example, the computer program product is in the form of a removable solid-state memory, e.g. a Universal Serial Bus (USB) drive. As explained above, the computer program product could also be embodied in a memory of a device, such as the computer program product 64 of FIG. 8. While the computer program 91 is here schematically shown as a section of the removable solid-state memory, the computer program can be stored in any way which is suitable for the computer program product, such as another type of removable solid-state memory, or an optical disc, such as a CD (compact disc), a DVD (digital versatile disc) or a Blu-Ray disc.

The aspects of the present disclosure have mainly been described above with reference to a few embodiments. However, as is readily appreciated by a person skilled in the art, other embodiments than the ones disclosed above are equally possible within the scope of the invention, as defined by the appended patent claims. Thus, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1-34. (canceled)

35. A method of determining packet loss in a fronthaul link between a baseband node and a radio node of a radio access network, the method being performed in a packet loss determine, the method comprising:
detecting at least one empty input data slot of a plurality of input data slots of a communication chain operation in a first time period, wherein the communication chain operation is one in a sequence of communication chain operations in a device on a receiving end of the fronthaul link;
determining that data was intended to be provided to the at least one empty input data slot; and
determining that a packet loss has occurred in the fronthaul link, based on the detecting the at least one empty input data slot and the determining that data was intended to be provided.

36. The method of claim 35, further comprising determining an aggregate metric of fronthaul loss, based on at least one occurrence of the determining that a packet loss has occurred.

37. The method of claim 36, further comprising providing a metric signal, based on the aggregate metric, to a link adaptation module.

38. The method of claim 37, wherein the metric signal is used by the link adaptation module to determine when to disregard user equipment (UE) feedback in a subsequent link adaptation.

39. The method of claim 36, further comprising:
comparing the aggregate metric against a threshold; and
providing a fronthaul loss signal to a link adaptation module when the aggregate metric indicates a fronthaul loss that is greater than the threshold.

40. The method of claim 39, further comprising determining, in the baseband node, the threshold based on a code rate of a data set encompassing data of the plurality of input data slots in the first time period.

41. The method of claim 35, wherein:
the method is applied for downlink communication;
the communication chain operation is orthogonal frequency domain multiplexing (OFDM); and
each one of the plurality of input data slots is configured to contain at least one modulated symbol.

42. The method of claim 35, wherein:
the method is applied for downlink communication;
the communication chain operation is precoding; and
each one of the plurality of input data slots is configured to contain at least one modulated symbol.

43. The method of claim 35, wherein:
the method is applied for downlink communication;
the communication chain operation is modulation; and
each one of the plurality of input data slots is configured to contain at least one binary word.

44. The method of claim 35, wherein:
the method is applied for uplink communication;
the communication chain operation is equalization; and
each one of the plurality of input data slots is configured to contain at least one complex value.

45. A packet loss determiner for determining packet loss in a fronthaul link between a baseband node and a radio node of a radio access network, the packet loss determiner comprising:
a processor; and
a memory storing instructions that, when executed by the processor, cause the packet loss determiner to:
detect at least one empty input data slot of a plurality of input data slots of a communication chain operation in a first time period, wherein the communication chain operation is one in a sequence of communication chain operations in a device on a receiving end of the fronthaul link;
determine that data was intended to be provided to the at least one empty input data slot; and
determine that a packet loss has occurred in the fronthaul link, based on the detecting the at least one empty input data slot and the determining that data was intended to be provided.

46. The packet loss determiner of claim 45, wherein the processer further causes the packet loss determiner to determine an aggregate metric of fronthaul loss, based on at least one occurrence of the determining that a packet loss has occurred.

47. The packet loss determiner of claim 46, wherein the processer further causes the packet loss determiner to provide a metric signal, based on the aggregate metric, to a link adaptation module.

48. The packet loss determiner of claim 47, wherein the metric signal is used by the link adaptation module to determine when to disregard user equipment (UE) feedback in a subsequent link adaptation.

49. The packet loss determiner of claim 46, wherein the processer further causes the packet loss determiner to:
compare the aggregate metric against a threshold; and
provide a fronthaul loss signal to a link adaptation module when the aggregate metric indicates a fronthaul loss that is greater than the threshold.

50. The packet loss determiner of claim 49, wherein the processer further causes the packet loss determiner to determine, in the baseband node, the threshold based on a code rate of a data set encompassing data of the plurality of input data slots in the first time period.

51. The packet loss determiner of claim 45, wherein:
the packet loss determiner is configured for downlink communication;
the communication chain operation is orthogonal frequency domain multiplexing (OFDM); and
each one of the plurality of input data slots is configured to contain at least one modulated symbol.

52. The packet loss determiner of claim 45, wherein:
the packet loss determiner is configured for downlink communication;
the communication chain operation is precoding; and
each one of the plurality of input data slots is configured to contain at least one modulated symbol.

53. The packet loss determiner of claim 45, wherein:
the packet loss determiner is configured for downlink communication;
the communication chain operation is modulation; and
each one of the plurality of input data slots is configured to contain at least one binary word.

54. A non-transitory computer-readable medium storing a computer program product for controlling a packet loss determiner, the computer program product comprising software instructions that, when run on the packet loss determiner, cause the packet loss determiner to:
detect at least one empty input data slot of a plurality of input data slots of a communication chain operation in a first time period, wherein the communication chain operation is one in a sequence of communication chain operations in a device on a receiving end of the fronthaul link;
determine that data was intended to be provided to the at least one empty input data slot; and
determine that a packet loss has occurred in the fronthaul link, based on the detecting the at least one empty input data slot and the determining that data was intended to be provided.
